(19) United States
(12) Patent Application Publication
(10) Pub. No.: US 2024/0257103 A1
(43) Pub. Date: Aug. 1, 2024

(54) SYSTEMS AND METHODS FOR ENABLING EVENT DRIVEN TRANSACTIONS

(71) Applicant: Bits Financial, Inc., Las Vegas, NV (US)

(72) Inventor: Jameson Rader, Las Vegas, NV (US)

(21) Appl. No.: 18/101,918

(22) Filed: Jan. 26, 2023

(51) Int. Cl. G06Q 20/36; G06Q 20/38

(52) U.S. Cl. CPC G06Q 20/367; G06Q 20/389; G06Q 20/384; G06Q 2220/00

(57) ABSTRACT

Systems and methods for enabling transaction triggers are provided. These transaction triggers may be created by users of the systems and methods. In some embodiments, the systems and methods described herein may comprise receiving a set of user account information, and generating at least one digital wallet associated with the set of user account information; receiving at least one permission for a smart contract to spend digital assets associated with the at least one digital wallet; receiving a set of instructions creating a trigger comprising a set of trigger conditions; receiving a data package indicating that the trigger conditions are met; and transmitting a data payload to the smart contract causing the smart contract to execute.

### BACKGROUND

The digital assets space that comprises a plethora of cryptocurrencies and other blockchain enabled assets is fraught with user pitfalls. The environment is one of high market volatility, very few entry-level educational resources for users to get up to speed on the digital assets space, and a variety of risks associated with centralized service providers that provide custody services for digital asset holders. Consequently, it can be difficult for users to know when to buy or sell digital assets in this environment subject to multiple hurdles and information asymmetries. What is needed is a solution that provides users with tools to address the aforementioned risks.

### BRIEF DESCRIPTION OF THE DRAWINGS

The figures described below depict various embodiments, features, and aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 illustrates an exemplary system for enabling event driven transactions according to an embodiment.

FIG. 2 illustrates an alternative exemplary system for enabling event driven transactions according to an embodiment.

FIG. 3 illustrates an exemplary system and method for a user to create a trigger condition for enabling event driven transactions according to an embodiment.

FIG. 4 illustrates an alternative exemplary system for enabling event driven transactions according to an embodiment.

FIG. 5 illustrates an alternative exemplary system for enabling event driven transactions according to an embodiment.

FIG. 6 illustrates an exemplary sequence diagram for illustrating a fee process as part of a system for enabling event driven transactions according to an embodiment.

FIG. 7 illustrates an exemplary user device for enabling event driven transactions according to an embodiment.

FIG. 8 illustrates an exemplary server for enabling event driven transactions according to an embodiment.

FIG. 9 illustrates an exemplary computer-implemented method for enabling event driven transactions according to an embodiment.

The figures depict aspects of the present embodiments for purposes of illustration only. One skilled in the art will readily recognize from the following discussion that alternate aspects of the structures and methods illustrated herein may be employed without departing from the principles of the invention described herein.

### DETAILED DESCRIPTION

Systems and methods for enabling transaction triggers are provided. These transaction triggers may be created by users of the systems and methods. In some embodiments, the systems and methods described herein may comprise receiving a set of user account information, and generating at least one digital wallet associated with the set of user account in-formation; receiving at least one permission for a smart contract to spend digital assets associated with the at least one digital wallet; receiving a set of instructions creating a trigger comprising a set of trigger conditions; receiving a data package indicating that the trigger conditions are met; and transmitting a data payload to the smart contract causing the smart contract to execute.

As discussed throughout, digital assets may mean a variety of things, such as, but not limited to, blockchain-based assets. These assets may be cryptocurrencies, tokens, crypto assets, nonfungible tokens, tokenized assets, security tokens, stablecoins, and central bank digital currencies.

Cryptocurrencies, tokens, and crypto assets may be any digital store of value or medium of exchange that is stored on a blockchain that can be used for investments, payments, funding a project.

Nonfungible tokens may be a token that may represent ownership and control of a unique digital item associated with a work of art, or other piece of valuable property. An NFT is an attestation that the holder of the NFT owns the underlying digital asset and can sell, trade, or redeem it in the free market. NFTs have a variety of uses, such as, for example, proving ownership of digital items, proving your identity and granting access (to either a virtual or physical space), and tokenizing a supply chain to track inventory movement and ownership.

Tokenized assets and security tokens may be digital assets that meet the definition of a security or other financial investment such as stocks and bonds. They may be tokenized versions of stocks (equity) and bonds, as well as tokenized versions of real-world assets like real estate, real property, or other personal property i.e., chattel.

A stablecoin may be a type of cryptocurrency designed for price stability guaranteed by real world asset backing or algorithmically guaranteed. Stablecoin prices may be related to government fiat currencies, commodities, or other crypto assets. Stablecoins may be used for payments, foreign exchange, cross-border payments and transfers, and facilitating transfers and trades between different types of digital assets.

Central bank digital currencies may be a type of digital asset that represents a nation's currency and is backed by a central bank. Central bank digital currencies may be used for payments, and cross-border payments and transfers.

In some instances, digital assets may mean information of value that is stored digitally. The information may be a secret that a user wishes to securely share with others, or information that a user wishes to securely acquire from others. Digital assets may be useful and interacted with via the Internet, a Metaverse, or during physical interactions. As stated above, the systems and methods described herein are configured to provide a user with the ability to enable event driven transactions in the variety of digital assets as described throughout.

A data payload may be a set of information embodied in digital format that comprises information that may be relevant to blockchain-based assets such as cryptocurrencies, tokens, crypto assets, nonfungible tokens, tokenized assets, security tokens, stablecoins, and central bank digital currencies. In particular, the data payload may comprise information that is necessary for interacting with, or effectuating transactions of, blockchain-based assets on a blockchain.

The systems and methods described herein provide tools that allow users to enable event-driven transactions via transaction triggers to purchase, sell, lend, or post as collateral, digital assets or store digital information according to those transaction triggers. The systems and methods herein provide a solution for users interested in a self-custodied and autonomous transaction driven framework to interact (acquire, buy, sell, lend, etc.) with digital assets. This all-in-one solution described by the systems and methods simplifies what has now been a multi-step process to a process consisting of a few simple steps for the user thereby unlocking a much larger part of the digital asset user market by multiple orders of magnitude. The solution may be encapsulated in a downloadable application that allows a user to interface with one service provider to achieve the results described herein.

In one embodiment, the systems and methods described herein provide a vertically integrated solution that allows users to engage in background trading. The systems and methods provide a vertically integrated solution via a mobile or desktop application, or via a website connected to a method of onboarding, or on-ramping, a user, a digital asset wallet, and connection to smart contracts, such as, for example, a decentralized finance (“DeFi”) liquidity trading pool. A user may enable background trading via this vertically integrated solution that allows the user to set trading strategies that occur as part of rounding up a transaction, setting a recurring transaction, boosting a transaction, or setting a trigger for a transaction.

Some additional digital asset trading strategies enabled by the systems and methods described herein include round ups, fear and greed index, whale watching, strategy stacking, social sentiment, dominance, volatility, copy-cats index, realized value, search trends, volume, copy-cats strategies, value averaging, net unrealized profit/loss, and event-triggered. The user may use the systems and methods described herein to enable triggers that effectuate the trading strategies described via transactions in a set of digital assets of interest in line with a selected trading strategy.

A round ups strategy may allow a user of the systems and methods to “round up” transaction amount via spare change investments in digital assets. A fear and greed index strategy may allow a user of the systems and methods to set a trading strategy that is based upon sentiment analysis of a particular digital asset market, or multiple digital asset markets, focused on the volatility, volume, social media mentions, dominance of the digital assets, and searches for the digital assets. A whale watching strategy may allow a user of the systems and methods disclosed herein to set a trading strategy that tracks known holders of particular digital assets and execute transactions in line with transactions undertaken by the holders that the user is made aware of via market movement notifications. A strategy stacking strategy may allow a user of the systems and methods to develop their own trading strategy that may employ elements from the various trading strategies described herein in a combination of their choosing. A social sentiment strategy may allow a user of the systems and methods to employ a trading strategy that is based upon positive and negative trends the user is aware of in social media postings. A dominance strategy may allow a user of the systems and methods to employ a trading strategy based upon the market share of a digital asset, or the size of a digital asset market capitalization in relation to other digital assets. A volatility strategy may allow a user of the systems and methods to deploy a trading strategy that is based upon a volatility target in a digital asset portfolio held or tracked by a user so that transactions occur to maintain the volatility target. A copy-cats index strategy may allow a user of the systems and methods to share their digital asset portfolio and trading strategy with others so that they may employ the same strategy, and similarly other users may do the same such that the user may follow their strategy. A realized value strategy may allow a user of the systems and methods to deploy a trading strategy that is based upon short-term and long-term indicators that are industry standard or set by the user for digital assets. A search trends strategy may allow a user of the systems and methods to employ a digital asset trading strategy based upon real-time market insights. A volume strategy may allow a user of the systems and methods to employ a digital asset trading strategy based upon the volume of traded digital assets over a period of time such as 12 hours, 24 hours, 72 hours, and the like. A copy-cats strategies strategy may allow a user of the systems and methods to base their trading strategy upon peer-to-peer monitoring of other users and their transaction activity. A value averaging strategy may allow a user of the systems and methods to employ a portfolio-based investing strategy for digital assets based on the average value of digital assets of interest. A net unrealized profit/loss strategy may allow a user of the systems and methods to employ a digital asset trading strategy that looks at the difference between unrealized profit and unrealized loss for a blockchain network as a whole to determine if the network is in a state of profit or loss and execute transactions in the digital assets accordingly. An event-triggered strategy may allow a user of the systems and methods to employ a digital asset trading strategy based upon monitoring real-life events through the use of third parties and tracking of events as set by the user to trigger transactions.

The systems and methods described herein may allow for a provider of the systems and methods to derive revenue from the services provided in a variety of ways, for example, fiat to crypto conversion fees via ACH on/off ramps, wrapped smart contracts that allow for trading fees at a fixed percentage as part of the service, and a decentralized assets under management fund that provides a yield percentage for the transactions.

The systems and methods described herein provide a variety of benefits to users. For example, the embodiments described herein significantly decrease the complexity involved in employing trading strategies in a digital asset. The embodiments described herein allow a user to employ event-driven trading strategies in as few as four steps that are all handled by one service provider who may effectuate their functionality via an application downloadable to computing devices. In one embodiment, the steps comprise downloading an application to a computing device, completing an on-ramping process to a service provider that developed the application, configure parameters for a trading strategy, such as triggers or other events to monitor, and completing a transaction in the digital assets of interest when those triggers or events are detected by the service.

Conversely, a traditional process trying to achieve the same result will typically have an order of magnitude more complexity in terms of the number of steps necessary to achieve the same result and the number of different entities involved in the process. In a typical scenario, a user would need to connect to a centralized digital asset exchange (“CEX”), go through a Know Your Customer (“KYC”) process, deposit funds to the CEX, wait a period of time (e.g., the period of time is typically 3 days), download a digital asset wallet, configure the networks they wish to interact with, select a particular blockchain of interest, send their funds from the CEX to their digital asset wallet, make their digital assets visible, navigate to a decentralized exchange (“DEX”), configure their trade, set the slippage related to the trade, sign a transaction for the trade, and complete the transaction. This process takes fourteen steps and may take more steps depending on the digital assets of interest.

The systems and methods described herein may perform some of the steps listed in the traditional process, for example, in some embodiments KYC may be performed by a third party, or internally by the systems and methods as part of the solution described herein.

Another benefit of the systems and methods described herein are the following characteristics: instant fiat on-ramping for users, full self-custody of digital assets, high token availability, seedless digital wallets (i.e. a digital wallet with a seed that a user does not need to see to make use of the wallet), entry-level user-friendly experience, background trading that occurs according to user customization, and trading strategy automation.

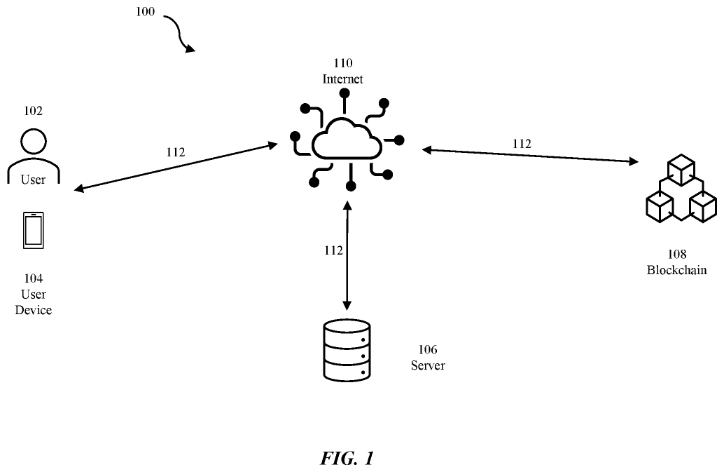

FIG. 1 illustrates an exemplary system 100 for enabling event driven transactions according to an embodiment. Put another way FIG. 1 illustrates an exemplary system 100 for enabling transaction trigger driven transactions according to an embodiment. FIG. 1 may include a user 102, a user device 104, a server 106, a blockchain 108, the Internet 110, and one or more network connections 112. The components included in FIG. 1 may be communicatively coupled together to effectuate the functionality described herein. In some embodiments, the figure may contain more or fewer components.

The user 102 may be an individual that wishes to trade in digital assets, or exchange information on a blockchain in a semi-automated fashion where they can set particular parameters for the transactions and know that any such transactions will occur in “the background” so to speak. The user 102 may sign up for a service provider that develops an application that contains the functionality described herein.

The user device 104 may be a computing device utilized by the user 102 to download and interact with the application. The computing device may be a smart phone, tablet, laptop, PC, phablet, smart watch, smart glasses, and the like.

The server 106 may be one or more servers that are able to interact with the user device 104 and a blockchain 108 via the Internet 110. The one or more servers may store relevant data and assist in effectuating the functionality of the service and downloadable application.

The blockchain 108 may be a decentralized ledger-based peer-to-peer network such as Bitcoin, Ethereum, Binance Smart Chain, Solana, Polkadot, Avalanche, Cosmos, Near, Algorand, Flow, Litecoin, Zcash, and the like. The blockchain 108 may have its own digital asset and be able to support additional types of digital assets that utilize the digital asset native to the blockchain in some capacity.

In one embodiment of FIG. 1 the system 100 and its components may be configured and communicatively coupled to enable transaction triggers. The system may comprise receiving, at one or more processors, a set of user account information, and generating at least one digital wallet associated with the set of user account information; receiving, at the one or more processors, at least one permission for a smart contract to spend digital assets associated with the at least one digital wallet; receiving, at the one or more processors, a set of instructions creating a trigger comprising a set of trigger conditions; receiving, at the one or more processors, a data package indicating that the trigger conditions are met; and transmitting, at the one or more processors, a data payload to the smart contract causing the smart contract to execute.

The method described above may make use of the components disclosed in FIG. 1, for example, the one or more processors may be located at the server 106 and may be responsible for receiving data, manipulating it according to the user specifications and trading strategy, and transmitting data to effectuate transactions on behalf of the user 102 in conjunction with an application downloaded to the user device 104. In particular, the user 102 may select the trigger conditions via the application downloaded to the user device 104. As part of the user 102 selecting trigger conditions the user 102 may be presented with a menu, or set of menus, that detail the various trading strategies that are available to them through the application. Similarly, the user account information may be information provided by the user 102 as part of signing up for the service provided via the application. Additionally, the user 102 may provision digital assets at their direction to the digital asset wallet.

The user 102 may provide the service with trigger conditions, or other events that they wish the service to monitor via the application. The trigger conditions, or events, may be such things as celebrities, politicians, business leaders, or athletes posting to social media or publishing articles or videos to the internet. Similarly, the trigger conditions may be stock prices, bond prices, or prices of other traditional financial instruments rising or falling in line with what the user wishes to track.

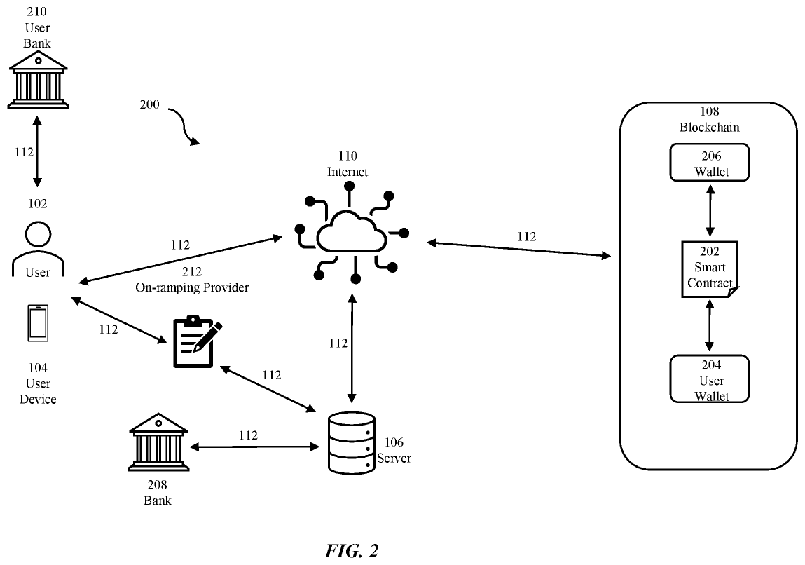

FIG. 2 illustrates an alternative exemplary system for enabling event driven transactions according to an embodiment. Put another way FIG. 2 illustrates an exemplary system for enabling transaction trigger driven transactions according to an embodiment. FIG. 2 may include a user 102, a user device 104, a server 106, a blockchain 108, the Internet 110, one or more network connections 112, a smart contract 202, a user wallet 204, a service provider wallet 206, a service provider bank 208, a user bank 210, and an on-ramping provider 212. The components included in FIG. 1 may be communicatively coupled together to effectuate the functionality described herein. In some embodiments, the figure may contain more or fewer components.

The smart contract 202 may be a set of instructions stored at a blockchain address that are configured to achieve the functionality of the systems and methods described herein. The user wallet 204 and service provider wallet 206 may be associated with addresses that have an associated digital wallet balance that are entries in the blockchain 108.

The service provider bank 208 and user bank 210 may be traditional banking institutions that allow for on ramping and off ramping of fiat currency into the systems and methods described herein. The on-ramping provider 212 may be a third party that the service provider that provides the functionality of the systems and methods described herein to the user 102 is engaged with to provide verification of user 102 information as part of the process to bring the user into the system.

In one embodiment, FIG. 2 may enable a computer implemented method for enabling transaction triggers. The computer-implemented method may comprise receiving, at one or more processors, a set of user account information, and generating at least one digital wallet associated with the set of user account information; receiving, at the one or more processors, at least one permission for a smart contract to spend digital assets associated with the at least one digital wallet; receiving, at the one or more processors, a set of instructions creating a trigger comprising a set of trigger conditions; receiving, at the one or more processors, a data package indicating that the trigger conditions are met; and transmitting, at the one or more processors, a data payload to the smart contract causing the smart contract to execute.

In some embodiments of the systems and methods disclosed in FIGS. 1 and 2 the user 102 may provide digital wallet information for a digital wallet already in existence that the user 102 controls. Said differently, in this embodiment generating at least one digital wallet in the system may further comprise verifying, at one or more processors, pre-existing digital wallet information provided by a user, and if the pre-existing digital wallet information is valid utilizing the pre-existing digital wallet associated with the pre-existing digital wallet information.

In some embodiments of the systems and methods disclosed in FIGS. 1 and 2 receiving the set of user account information may further comprise receiving, at the one or more processors, the set of user account information from a third party. The third party may be an onboarding or on-ramping service provider that may verify the validity of the user account information provided by the user 102.

In some embodiments of the systems and methods disclosed in FIGS. 1 and 2 granting at least one permission to a smart contract to spend digital assets associated with the at least one digital wallet may comprise a user ability to revoke the at least one permission to spend digital assets granted to the smart contract.

In some embodiments of the systems and methods disclosed in FIGS. 1 and 2 receiving a set of instructions creating a trigger comprising a set of trigger conditions may further comprise a user providing instructions to execute a transaction, at the one or more processors, for digital assets based upon activity on a social media network. The instructions may contain information necessary to employ a trading strategy selected by the user 102.

In some embodiments of the systems and methods disclosed in FIGS. 1 and 2 receiving a set of instructions creating a trigger comprising a set of trigger conditions may further comprise monitoring, at the one or more processors, activity on a social media network for activity that matches the trigger conditions. The monitoring may take the form of the processors executing instructions for a program that tracks a set of social media accounts as designated by the user 102.

In some embodiments of the systems and methods disclosed in FIGS. 1 and 2 receiving the data package indicating that the trigger conditions are met may further comprise verifying, at the one or more processors, that the data package comprises data that satisfies the trigger conditions set by a user. The data that satisfies the trigger conditions may be something such as a social media account posting something to their timeline. In other embodiments, the data may be a news story occurring, a geopolitical event, a sporting event or an athlete achieving or not achieving benchmarks, financial reporting, milestones for projects of interest, and/or a certain time of year or time of day, etc.

In some embodiments of the systems and methods disclosed in FIGS. 1 and 2 transmitting a data payload to the smart contract causing the smart contract to execute may further comprise updating, at a blockchain, a digital wallet that exists on the blockchain with information about the transaction to the smart contract. The update may take the form of crediting or debiting the amount of a digital asset that is associated with that digital wallet.

The systems and methods disclosed in FIGS. 1 and 2 may further comprise generating, at the one or more processors, a fee associated with the transaction to the smart contract. The fee may be a payment to the service provider as part of providing the functionality of the systems and methods depicted in FIG. 1 for the user 102. The fee may be collected at the moment a set of instructions are created, shortly thereafter, or when a trigger condition occurs. For example, a fee may be collected when the user 102 puts in an order “buy $DOGE when Elon Musk tweets about $DOGE.”

The systems and methods disclosed in FIGS. 1 and 2 may further comprise generating, at the one or more processors, a notification to a user based on the transaction to the smart contract. The notification to the user 102 may be a notification presented to the user 102 on the user device 104 indicating success or failure of a transaction that was executed because of the existence of trigger conditions detected by the service provider.

The systems and methods depicted in FIGS. 1 and 2, and the components pictured therein, may be configured to enable event-driven transactions at a smart contract. For example, the systems and methods may comprise receiving, at one or more processors, a set of user account information, and generating at least one digital wallet associated with the set of user account information; creating, at the one or more processors, a container associated with the smart contract and funded with digital assets from the at least one digital wallet, wherein the digital assets stored within the container are locked up and may be transmitted upon the satisfaction of a set of criteria; receiving, at the one or more processors, a set of instructions creating a trigger comprising the set of criteria; receiving, at the one or more processors, a set data package indicating that the set of criteria are met; and transmitting, at the one or more processors, a data payload to the smart contract causing the smart contract to execute and the funds stored at the container to transmit.

In the above embodiment, the container may take the form of a data array in the smart contract where entries in the array are locations in which a user may store, or lock-up, digital assets or other information that they wish to unlock when certain conditions are met. The conditions to meet may be trigger conditions set by the user that are of a variety of types as described above. In other embodiments, the container may be a “child smart contract” that is separate from the smart contract and is considered a child to the smart contract because of its relationship to the smart contract. The child smart contract may be located at a different blockchain address from the smart contract. The relationship between the two smart contracts may comprise cross reference to each other as indicated by the user and stored at the respective smart contracts. The user may lock digital assets up in the child smart contract or set conditions upon which digital assets may be released from the smart contract.

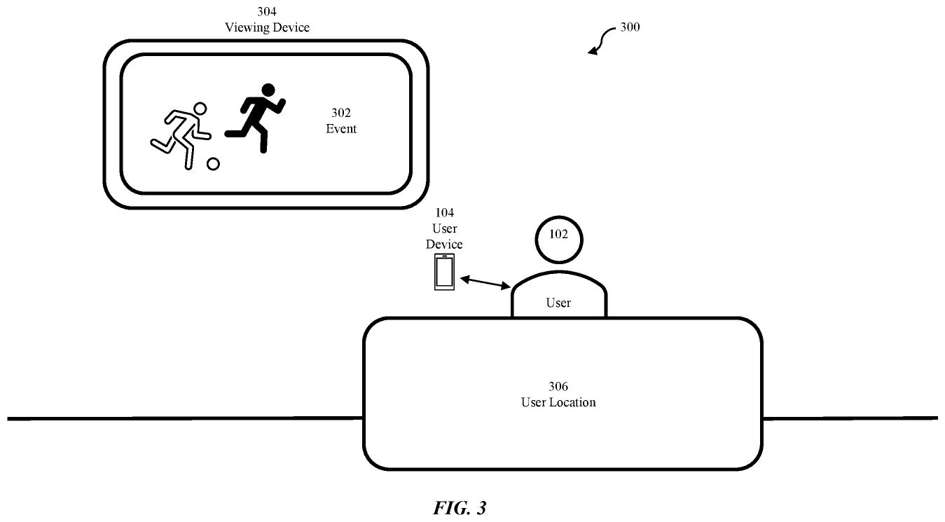

FIG. 3 illustrates an exemplary system 300 and method for a user to create a trigger condition for enabling event driven transactions according to an embodiment. FIG. 3 may 3 may include a user 102, a user device 104, an event 302, a viewing device 304, and a user location 306. The user 102 and user device 104 may be the same as those in FIGS. 1 and 2 with the same functionality and characteristics. The viewing device 304 could be a television, a computer, a tablet, a phablet, a smartphone, or some other hardware device that allows for the user 102 to watch and or listen to content. Similarly, the user location 306, may be a couch or chair at their home, or the like, as well as a location such as their office, a park, a coffee shop, a friend's house, etc. In some embodiments, the figure may contain more or fewer components.

In FIG. 3, the user 102 may be viewing an event 302 of interest on the viewing device 304 while at their user location 306. The event 302 may an event that the user watches or listens to such as a sporting event, a movie or television show, a concert, a video game competition, a news program, a podcast, financial news broadcasts, world news broadcasts, a feed on a social media network such as Twitter®, Facebook®, Instagram®, Snapchat®, YouTube®, or TikTok® and the like. The user 102 may see or hear something that catches their attention and decide that they would like to take that moment to set up a trade using the system described in FIGS. 1 and 2. The user 102 upon hearing or seeing the event of interest 302 may then use the system to execute or set the conditions for execution of a trade in cryptocurrency or another digital asset. For example, in FIG. 3 as depicted the user 102 may be watching the World Cup® on their viewing device 304 and see the country Saudi Arabia score a goal against the country Argentina and decide to setup instructions for the system to buy bitcoin if Saudi Arabia ultimately wins the match. If the condition subsequently occurs the trade is executed. Similarly, the user 102 may be scrolling through their Twitter feed and decide to set up a buy order for purchasing dogecoin any time that Elon Musk tweets about dogecoin.

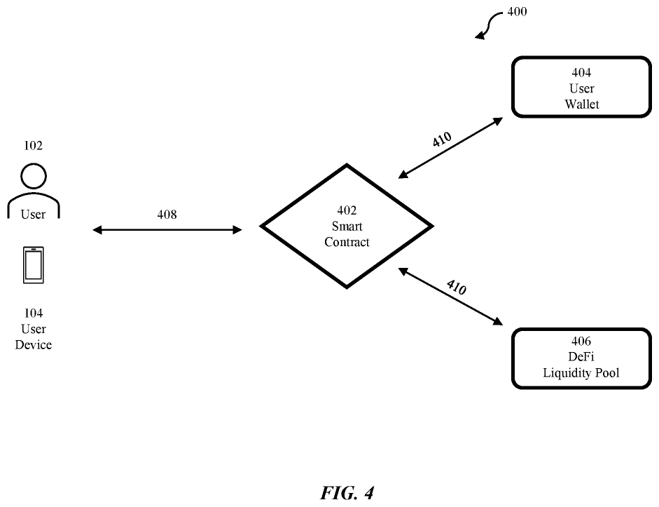

FIG. 4 illustrates an alternative exemplary system 400 for enabling event driven transactions according to an embodiment. FIG. 4 may include a user 102, a user device 104, a smart contract 402, a user crypto wallet 404, a DeFi liquidity pool 406, a network connection 408, and blockchain connections 410. The user 102 and user device 104 may be the same as those in FIGS. 1 and 2 with the same functionality and characteristics. The network connection 408 may be similar to the network connections 112 as described with respect to FIGS. 1 and 2. The blockchain connections 410 may mean that the smart contract 402, user crypto wallet 404 and DeFi Liquidity Pool 406 are communicatively coupled to each other according to the rules of the underlying blockchain network on which they exist. In some embodiments, the figure may contain more or fewer components.

In FIG. 4, the user 102 may set up event driven transactions on their user device 402 that leverage the functionality described with respect to FIGS. 1 and 2, and throughout the rest of this document, such that the trades they wish to execute involve communication between the user device 104 and the smart contract 402, user wallet 404 and DeFi Liquidity Pool 406.

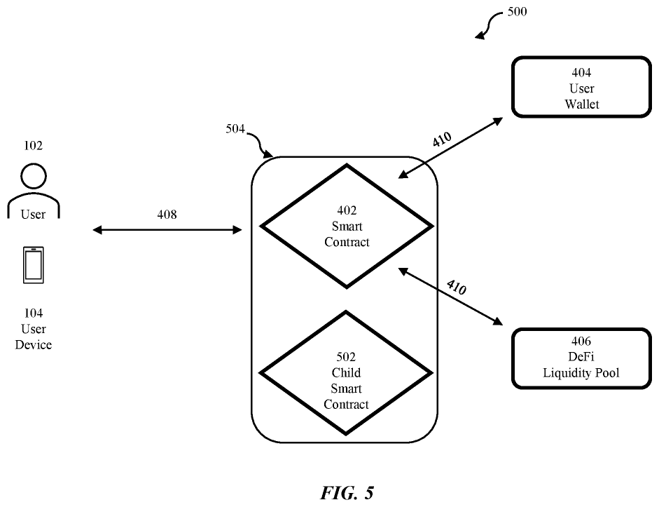

FIG. 5 illustrates an alternative exemplary system 500 for enabling event driven transactions according to an embodiment. FIG. 5 may include a user 102, a user device 104, a smart contract 402, a user crypto wallet 404, a DeFi liquidity pool 406, a network connection 408, blockchain connections 410, and a child smart contract 502. The user 102 and user device 104 may be the same as those in FIGS. 1 and 2 with the same functionality and characteristics. The network connection 408 may be similar to the network connections 112 as described with respect to FIGS. 1 and 2. The blockchain connections 410 may mean that the smart contract 402, user crypto wallet 404 and DeFi Liquidity Pool 406 are communicatively coupled to each other according to the rules of the underlying blockchain network on which they exist. In some embodiments, the figure may contain more or fewer components.

In FIG. 5, the user 102 may set up event driven transactions on their user device 402 that leverage the functionality described with respect to FIGS. 1 and 2, and throughout the rest of this document, such that the trades they wish to execute involve communication between the user device 104 and the smart contract 402, user wallet 404 and DeFi Liquidity Pool 406. Additionally, in FIG. 5 the user 102 has the ability to lock up digital assets in the child smart contract 502 to be used in any purchases for digital assets that occur as the result of event driven transactions. The smart contract 402 and child smart contract 502 have a communicative relationship with each other as embodied by the boundary 504. The child smart contract 502 may in some implementations be a separate smart contract from smart contract 402, but in other implementations it may be a part of the code that constitutes the smart contract 402 existing as a logically separate vault for the protection of user 102 funds.

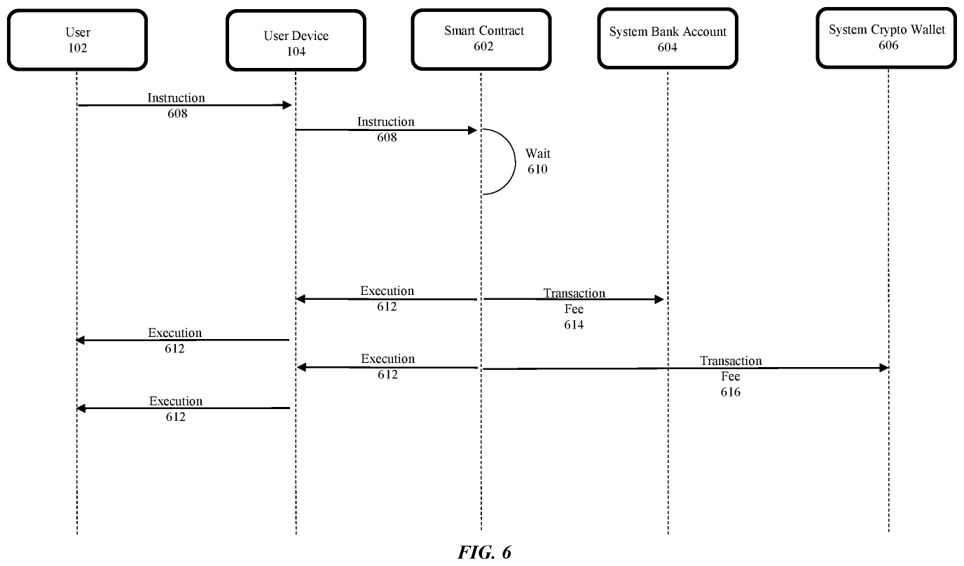

FIG. 6 illustrates an exemplary sequence diagram 600 for illustrating a fee process as part of a system for enabling event driven transactions according to an embodiment. FIG. 6 may 6 may include a user 102, a user device 104, a smart contract 602, a system bank account 604, and a system crypto wallet 606. The components depicted in FIG. 6 may be communicatively coupled to effectuate the interactions necessary for the functionality described herein. The user 102 and user device 104 may be the same as those in FIGS. 1 and 2 with the same functionality and characteristics. In some embodiments, the figure may contain more or fewer components.

In FIG. 6, the user 102 may send an event driven trigger instruction 608 to the user device 104. The user device 104 may correspondingly send the event driven trigger instruction 608 to the smart contract 602 where it will be stored and wait 610 for execution conditions to occur. In the event that the execution conditions occur an execution message 612 may be sent to the user device 104 and presented to the user 102. At about the same time a transaction fee 614 or 616 may be sent to either the system bank account 604 or the system crypto wallet 606 as a fee for the service that provides the event driven transaction processing system as described herein. In some embodiments, the transaction fee may be collected at the moment an event driven trigger instruction is created or shortly after.

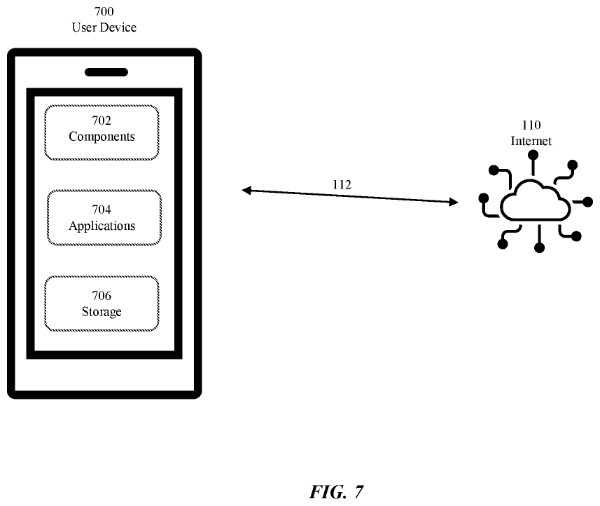

FIG. 7 illustrates an exemplary user device 700 for enabling event driven transactions according to an embodiment. FIG. 7 may include a set of components 702 that may include processors, memories, input/output connections, interfaces for machine/human interaction, as well as any other necessary components, a suite of applications 704, storage 706, Internet 110, and network connection 112. The components in FIG. 7 may be configured to perform the functionality described herein and in particular the functionality described with respect to FIG. 1-6. In some embodiments, the figure may contain more or fewer components.

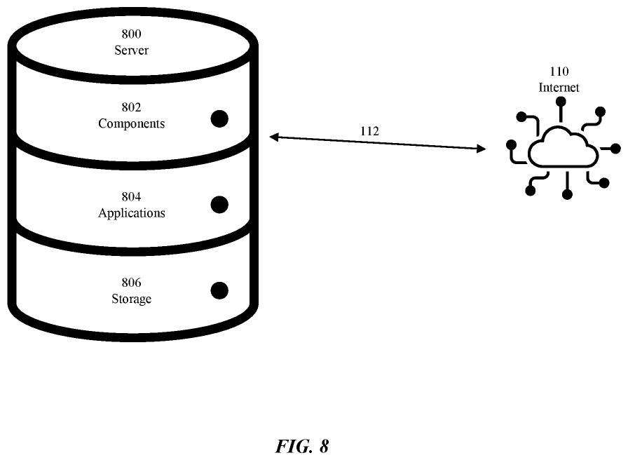

FIG. 8 illustrates an exemplary server 800 for enabling event driven transactions according to an embodiment. FIG. 8 may include a set of components 802 that may include processors, memories, input/output connections, interfaces for machine/human interaction, as well as any other necessary components, a suite of applications 804, storage 806, Internet 110, and network connection 112. The components in FIG. 8 may be configured to perform the functionality described herein and in particular the functionality described with respect to FIG. 1-6. In some embodiments, the figure may contain more or fewer components.

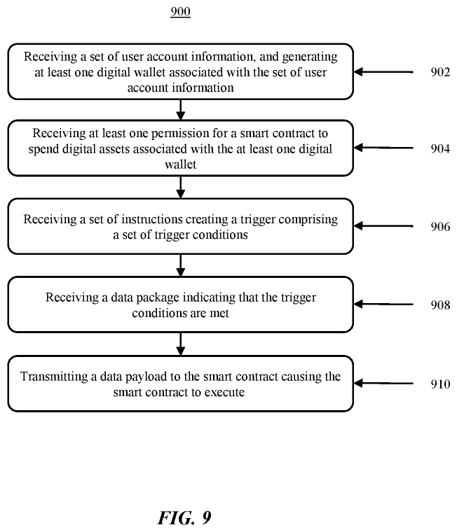

FIG. 9 illustrates an exemplary computer-implemented method for enabling event driven transactions according to an embodiment. The computer-implemented method 900 may comprise receiving, at one or more processors, a set of user account information, and generating at least one digital wallet associated with the set of user account information (block 902); receiving, at the one or more processors, at least one permission for a smart contract to spend digital assets associated with the at least one digital wallet (block 904); receiving, at the one or more processors, a set of instructions creating a trigger comprising a set of trigger conditions (block 906); receiving, at the one or more processors, a data package indicating that the trigger conditions are met (block 908); and transmitting, at the one or more processors, a data payload to the smart contract causing the smart contract to execute (block 910). In some embodiments, the figure may contain more or fewer steps.

Some embodiments of the systems and methods described in FIGS. 1-9 may take the form of a system for enabling transaction triggers. In particular, the systems and methods may comprise a user device associated with a user; at least one or more servers; and a smart contract, wherein the smart contract is deployed to a blockchain. The at least one or more servers may be configured to receive a set of user account information from the user device, and generate at least one digital wallet associated with the set of user account information, receive at least one permission, from the user, for the smart contract to spend digital assets associated with the at least one digital wallet, receive a set of instructions, from the user device as indicated by the user, creating a trigger comprising a set of trigger conditions, receive a data package indicating that the trigger conditions are met, and transmit a data payload to the smart contract causing the smart contract to execute. The system may be configured to perform the additional functionality of the systems and methods described in relation to FIGS. 1-9 as additional embodiments.

The functionality described with respect to the systems and methods described in FIGS. 1-9 may be embodied in machine-readable instructions stored in a computer-readable medium that cause a processor, and any associated memories and servers or other computing devices as necessary to execute operations that achieve the desired results.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirt and scope of the appended claims. For example. It is to be understood that the present technology contemplates that, to the extent possible, one or more features of any implementation can be combined with one or more features of any other implementation.

The methods and systems discussed herein may be implemented via one or more processing devices (e.g., a digital processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

The server(s) and client computing platform(s) may be communicatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s), client computing platform(s), and any other discussed third parties may be operatively linked via some other communication media.

A given client computing platform may include one or more processors configured to execute computer program modules. The computer program modules may be configured to enable a user associated with the given client computing platform to interface with the described systems and methods and/or provide other functionality attributed herein to client computing platform(s). By way of non-limiting example, the given client computing platform may include one or more of a desktop computer, a laptop computer, a handheld computer, a tablet computing platform, a Smartphone, a gaming console, a VR/AR headset or other device, a computing device that accesses a Metaverse where NFTs or other digital assets may or may not be viewable, and/or other computing platforms. A Metaverse may be a virtual world accessible to users via a VR/AR headset or other device, or some other computing device that allows a user to access and interact with digital items and digital communities. As part of the Metaverse a user may be able to view and interact with a NFT or other digital assets as it exists in relation to other digital items and digital communities.

Server(s) may include electronic storage and one or more processors, and/or other components. Server(s) may include communication lines, or ports to enable the exchange of information with a Network and/or other computing platforms. Illustration of server(s) is not intended to be limiting. Server(s) may include a plurality of hardware, software, and/or firmware components operating together to provide the functionality attributed herein to servicer(s). For example, server(s) may be implemented by a cloud of computing platforms operating together as server(s).

The electronic storage media may comprise non-transitory storage media that electronically stores information. The electronic storage media may include one or both of system storage that is provided integrally (i.e., substantially non-removable) with server(s) and/or removable storage that is removably connectable to server(s) via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private Network, and/or other virtual storage resources). The electronic storage may store software algorithms, information determined by processor(s), information received from server(s), information received from client computing platform(s), databases and/or other information that enables server(s) to function as described herein.

Processor(s) may be configured to provide information processing capabilities in server(s). As such, processor(s) may include one or more of a digital processor, an analog processor, a digital circuit designed to process information, an analog circuit designed to process information, a state machine, and/or other mechanisms for electronically processing information. Although processor(s) may function as a single entity, in other implementations, processor(s) may include a plurality of processing units. These processing units may be physically located within the same device, or processor(s) may represent processing functionality of a plurality of devices operating in coordination. Processor(s) may be configured to execute instructions for applications, or modules, by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

The various messaging and data transfer described above may be accomplished with a REST API (or “RESTful” API). A RESTful API is an application program interface (API) that uses HTTP calls to request resources as opposed to functions. The function is embedded in the HTTP call through requests to GET, PUT, POST and DELETE, for example. The API spells out the proper way to request data, from an operating system or other application and allows management of customer data, sales orders, inventory, and products.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are in some embodiments directed to an improvement to computer functionality and may improve the functioning of conventional computers.

I claim:

1. A computer implemented method for enabling transaction triggers, comprising:
receiving, at one or more processors, a set of user account information, and generating at least one digital wallet associated with the set of user account information;
receiving, at the one or more processors, at least one permission for a smart contract to spend digital assets associated with the at least one digital wallet;
receiving, at the one or more processors, a set of instructions creating a trigger comprising a set of trigger conditions;
receiving, at the one or more processors, a data package indicating that the trigger conditions are met; and
transmitting, at the one or more processors, a data payload to the smart contract causing the smart contract to execute.

2. The computer implemented method of claim 1, wherein generating at least one digital wallet further comprises:
verifying, at one or more processors, pre-existing digital wallet information provided by a user, and if the pre-existing digital wallet information is valid utilizing the pre-existing digital wallet associated with the pre-existing digital wallet information.

3. The computer implemented method of claim 1, wherein receiving the set of user account information further comprises:
receiving, at the one or more processors, the set of user account information from a third party.

4. The computer implemented method of claim 1, wherein granting at least one permission to a smart contract to spend digital assets associated with the at least one digital wallet comprises:
a user ability to revoke the at least one permission to spend digital assets granted to the smart contract.

5. The computer implemented method of claim 1 wherein receiving a set of instructions creating a trigger comprising a set of trigger conditions further comprises:
a user providing instructions to execute a transaction, at the one or more processors, for digital assets based upon activity on a social media network.

6. The computer implemented method of claim 1 wherein receiving a set of instructions creating a trigger comprising a set of trigger conditions further comprises:
monitoring, at the one or more processors, activity on a social media network for activity that matches the trigger conditions.

7. The computer implemented method of claim 1 wherein receiving the data package indicating that the trigger conditions are met further comprises:
verifying, at the one or more processors, that the data package comprises data that satisfies the trigger conditions set by a user.

8. The computer implemented method of claim 1, wherein transmitting a data payload to the smart contract causing the smart contract to execute further comprises:
updating, at a blockchain, a digital wallet that exists on the blockchain with information about the transaction to the smart contract.

9. The computer implemented method of claim 1, further comprising:
generating, at the one or more processors, a fee associated with the transaction to the smart contract.

10. The computer implemented method of claim 1, further comprising:
generating, at the one or more processors, a notification to a user based on the transaction to the smart contract.

11. A system for enabling transaction triggers, comprising:
a user device associated with a user;
at least one or more servers; and
a smart contract, wherein the smart contract is deployed to a blockchain;
wherein the at least one or more servers is configured to receive a set of user account information from the user device, and generate at least one digital wallet associated with the set of user account information,
receive at least one permission, from the user, for the smart contract to spend digital assets associated with the at least one digital wallet,
receive a set of instructions, from the user device as indicated by the user, creating a trigger comprising a set of trigger conditions,
receive a data package indicating that the trigger conditions are met, and
transmit a data payload to the smart contract causing the smart contract to execute.

12. The system of claim 11, wherein to generate at least one digital wallet the at least one or more servers is further configured to:
verify pre-existing digital wallet information provided by the user, and if the pre-existing digital wallet information is valid utilizing the pre-existing digital wallet associated with the pre-existing digital wallet information.

13. The system of claim 11, wherein to receive the set of user account information the at least one or more servers is further configured to:
receive the set of user account information from a third party.

14. The system of claim 11, wherein to receive at least one permission for the smart contract to spend digital assets associated with the at least one digital wallet the at least one or more servers is further configured to:
receive a user ability to revoke the at least one permission to spend digital assets granted to the smart contract.

15. The system of claim 11, wherein to grant at least one permission for the smart contract to spend digital assets associated with the at least one digital wallet the at least one or more servers is further configured to:
create a child smart contract funded with digital assets from a user's digital wallet, wherein the child smart contract comprises digital assets stored within that are locked up and may be transmitted upon the satisfaction of a set of criteria.

16. The system of claim 11, wherein to receive a set of instructions creating a trigger comprising a set of trigger conditions the at least one or more servers is further configured to:
receive instructions, from the user device as indicated by the user, to execute a transaction for digital assets based upon activity on a social media network.

17. The system of claim 11, wherein to receive a set of instructions creating a trigger comprising a set of trigger conditions the at least one or more servers is further configured to:
monitor activity on a social media network for activity that matches the trigger conditions.

18. The system of claim 11, wherein to receive the set data package indicating that the trigger conditions are met the at least one or more servers is further configured to:
verify that the set data package matches the trigger conditions set by a user.

19. The system of claim 11, wherein to transmit a transaction to the smart contract causing the smart contract to execute the at least one or more servers is further configured to:
update the digital assets at the digital wallet with information about the transaction to the smart contract.

20. The system of claim 11, wherein the at least one or more servers is further configured to:
generate a fee associated with the transaction to the smart contract.

21. The system of claim 11, wherein the smart contract is further configured to:
interact with a liquidity pool, interact with a decentralized exchange, generate yield, or enable lending or borrowing based on the received data payload.

22. The system of claim 11, wherein the at least one or more servers is further configured to:
generate a notification to the user based on the transaction to the smart contract.

23. A computer implemented method for enabling event-driven transactions at a smart contract, comprising:
receiving, at one or more processors, a set of user account information, and generating at least one digital wallet associated with the set of user account information;
creating, at the one or more processors, a container associated with the smart contract and funded with digital assets from the at least one digital wallet, wherein the digital assets stored within the container are locked up and may be transmitted upon the satisfaction of a set of criteria;
receiving, at the one or more processors, a set of instructions creating a trigger comprising the set of criteria;
receiving, at the one or more processors, a set data package indicating that the set of criteria are met; and
transmitting, at the one or more processors, a data payload to the smart contract causing the smart contract to execute and the funds stored at the container to transmit.
